(19) United States
(12) Patent Application Publication
(10) Pub. No.: US 2006/0105797 A1
(43) Pub. Date: May 18, 2006

(54) Method and apparatus for adjusting a mobile communication device's transmission power

(75) Inventors: Mark J. Marsan, Elmhurst, IL (US); David A. Hensley, Wheaton, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 10/986,613

(22) Filed: Nov. 12, 2004

(51) Int. Cl. H04B 7/00

(52) U.S. Cl. 455/522

(57) ABSTRACT

A bandwidth monitor (14) monitors (21) the bandwidth of a transmission channel for a given wireless communication device (10), and a signal quality factor monitor (15) monitors (22) a signal quality factor relating to the wireless communication device's transmission. In response to the monitored factors, a transmission power setting unit (13) for the wireless communication device transceiver (12) typically adjusts (32) the transmission power for the wireless communication device (10) to maintain an essentially constant transmission power per unit bandwidth and to maintain an essentially constant signal strength as measured at the base station (11). Optionally, the transmission power is not increased if the signal quality factor exceeds a predetermined level or if the transmission power may fluctuate above the maximum transmission power for the wireless communication device (10).

### TECHNICAL FIELD

This invention relates generally to wireless communication systems and more particularly to systems wherein a given wireless communication device employs a variable bandwidth transmission capability.

### BACKGROUND

Wireless communication systems of various kinds are known in the art. Many such systems typically include wireless communication devices with a variable transmission power capability. Some wireless communication systems known in the art include wireless communication devices with variable transmission bandwidth capabilities.

Wireless communication devices with variable transmission bandwidth capabilities typically increase the bandwidth of the device when it is necessary to send or receive large amounts of data or other information. Doing so decreases the transmission time for sending or receiving the data. Transmission at a larger bandwidth but at the same transmission power, however, reduces the effective power of the transmission across the bandwidth. In other words, a wireless communication device will typically transmit at a given power regardless of the bandwidth of the transmission. If the wireless communication device transmits at a large bandwidth, there is less power available to transmit each unit of bandwidth than if transmitting at a smaller bandwidth. This drop in transmission power per unit of bandwidth thereby potentially harms the received signal strength and signal quality.

Also, in certain systems with variable bandwidth transmission capabilities, the actual transmission power fluctuates above and below an average transmission power during normal use because of the modulation of the transmission. An example of such a technology is the so-called Wideband iDEN® (WiDEN) technology where the transmission power fluctuates when communicating at certain bandwidths. Such volatility in the transmission power creates problems when increasing a wireless communication device's transmission power because the volatility may push the transmission power beyond the maximum transmission power capabilities for a given wireless communication device.

### BRIEF DESCRIPTION OF THE DRAWINGS

The above needs are at least partially met through provision of the method and apparatus for adjusting a mobile communication device's transmission power described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention; and

FIG. 4 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, the bandwidth of a transmission channel for a wireless communication device is monitored. Additionally, a signal quality factor measuring the signal quality between the wireless communication device and a base station is monitored. Then, the transmission power for the wireless communication device is adjusted as a function, at least in part, of the bandwidth and signal quality factor.

So configured, the transmission power for a wireless communication device can be increased when transmitting at a higher bandwidth resulting in a consistent signal quality regardless of the transmission bandwidth. Also, the transmission power can be maintained when the signal quality indicates that no benefit will be gained by increasing the transmission power, thereby conserving battery life when a wireless communication device is used near a base station. The result is a dynamically controlled transmission power such that the signal received at the base station is essentially constant thereby limiting interference with other wireless communication devices.

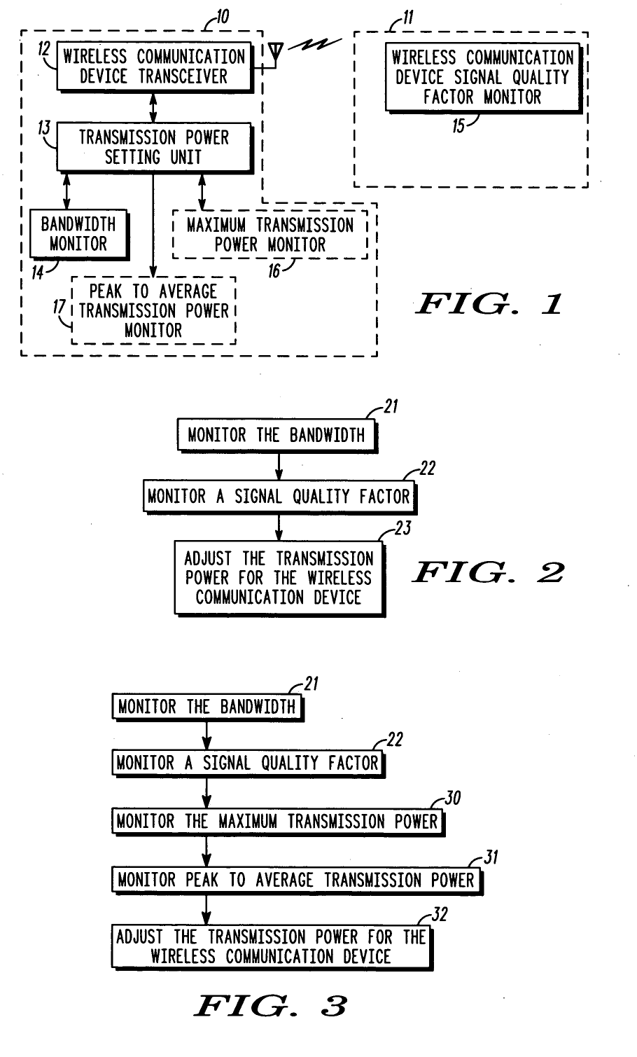

Referring now to the drawings and in particular to FIG. 1, a wireless communication device 10 is in communication with a base station 11. The wireless communication device 10 is capable of transmitting information at a plurality of bandwidths to the base station 11. The wireless communication device 10 includes a wireless communication device transceiver 12 that is responsive to transmission power setting unit 13. As known in the art, the transmission power setting unit 13 alternatively may be integral with the wireless communication device transceiver 12. The transmission power setting unit 13 controls the transmission power of the transceiver. Thus, through the transmission power setting unit 13, the wireless communication device transceiver 12 is responsive to the wireless communication device transmission channel bandwidth monitor 14. The bandwidth monitor 14, as known in the art, resides within the wireless communication device 10 and detects the bandwidth at which the wireless communication device 10 transmits.

The base station 11 includes a wireless communication device signal quality factor monitor 15. The signal quality factor monitor 15, as known in the art, monitors the signal quality of the signals received by the base station 11 from the wireless communication device 10. The base station 11 then sends back to the wireless communication device 10 the signal quality factor as determined by the signal quality factor monitor 15. The wireless communication device transceiver 12, through the transmission power setting unit 13, is responsive to the signal quality factor received from the base station 11 and the wireless communication device signal quality factor monitor 15. Alternatively, the signal quality factor monitor 15 can be located within the wireless communication device 10 where it detects the signal quality of transmissions received from the base station 11 to determine the a signal quality factor.

The wireless communication device 10 alternatively includes a maximum transmission power monitor 16 and a peak to average transmission power monitor 17. The maximum transmission power monitor 16, as known in the art, detects the maximum transmission power for the wireless communication device 10. Similarly, the peak to average transmission power monitor 17 measures a factor corresponding to the difference between the peak transmission power fluctuation from the average transmission power and the average transmission power for the wireless communication device 10. Such a device is known in the art. Alternatively, a single monitor may monitor both the maximum transmission power and the peak to average transmission power. In yet another embodiment, the maximum transmission power is determined prior to use and stored permanently within the wireless communication device 10. The maximum transmission power monitor 16 is hereby defined to include this stored setting in such embodiments where the maximum transmission power monitor 16 does not actively monitor the maximum transmission power. The wireless communication device transceiver 12, through the transmission power setting unit 13, is responsive to the maximum transmission power monitor 16 and the peak to average transmission power monitor 17.

A method of operation for adjusting the transmission power in accordance with the various embodiments of the invention will now be further described with reference to FIG. 2. The bandwidth monitor 14 monitors 21 the bandwidth of a transmission channel through which the wireless communication device 10 is transmitting. Further, the signal quality factor monitor 15 monitors 22 a signal quality factor. Then, the transmission power setting unit 13 adjusts 23 the transmission power for the wireless communication device as a function, at least in part, of the bandwidth and the signal quality factor. One should note that the monitoring steps of FIG. 2 can be performed in any order or at the same time.

One skilled in the art will recognize that various embodiments can be applied to wireless communication devices using any number of transmission technologies. For example, the wireless communication device may be transmitting over a data transmission channel. Alternatively, the wireless communication device 10 may utilize the variable bandwidth technology known as WiDEN technology. As known in the art, WiDEN technology allows for a wireless communication device to transmit at any one of up to four bandwidths: 25 kHz, 50 kHz, 75 kHz, and 100 kHz. Thus, the bandwidth monitor, when used in an embodiment utilizing WiDEN technology, will detect a transmission channel bandwidth of one of 25 kHz, 50 kHz, 75 kHz, or 100 kHz.

Similarly, one skilled in the art will recognize that the signal quality factor monitor 15 may monitor one or more of several possible measures of signal quality. For example, the signal quality factor monitor 15 may monitor 22 such known measures as a power control constant, a magnitude of signal, a ratio of desired signal to undesired signal, a bit error rate, and the like. Each such factor is a measure of the signal quality, and any of the factors alone or in combination can be incorporated into a signal quality factor measured by the signal quality factor monitor 15.

In a preferred embodiment, the transmission power for a wireless communication device 10 will typically be increased in response to a monitored 21 increase in bandwidth. The increase in transmission power offsets the loss in power per unit bandwidth experienced when a wireless communication device 10 transmits at higher bandwidths. Preferably, the wireless communication device transceiver 12 via the transmission power setting unit 13 adjusts the transmission power in response to the monitors 14 and 15 such that the strength of signal of the transmission from the wireless communication device 10 as measured at the base station 11 is essentially constant per unit bandwidth over a substantial range of distance between the wireless communication device 10 and the base station 11. To do so, the transceiver accounts for changes in signal strength due to bandwidth changes and changes in the signal quality factor.

For example, if a given wireless communication device 10 transmits at 10 mW at a 25 kHz bandwidth, the transmission power per unit bandwidth is 10 mW per 25 kHz or 0.4 mW/kHz. If the wireless communication device then transmits at a 50 kHz bandwidth, the transmission power per unit bandwidth will be 10 mW per 50 kHz or only 0.2 mW/kHz if the transmission power is not adjusted. To maintain the transmission power per unit bandwidth and thereby the signal quality, the transmission power is adjusted to 20 mW in the situation where the bandwidth is increased to 50 kHz to keep the power per unit bandwidth at the constant 10 mW per 25 kHz. By adjusting the transmission power as above, the signal quality, including signal strength, of the transmission as received at the base station should remain essentially constant.

To further maintain an essentially constant signal quality, the transmission power will be adjusted in response to the signal quality factor measured 22 by the signal quality factor monitor 15. The signal quality factor is a measure of the physical limitations on the communication between the wireless communication device 10 and the base station 11. Such limitations include the distance and physical barriers between the wireless communication device 10 and the base station 11. The signal quality factor will change to indicate a change in transmission quality such as when the wireless communication device 10 moves away from the base station 11 or moves inside a building. To maintain an essentially constant quality factor, the transmission power will be increased if the signal quality factor indicates a loss in signal quality.

The signal quality, however, will inevitably increase and decrease at the limits of the wireless communication device's 10 dynamic power adjustment. As such, the signal quality will decrease when the wireless communication device 10 reaches the outer ranges of the operable distance from the base station 11. Similarly, the signal quality will likely increase as the wireless communication device 10 comes within a given distance from the base station 11. For the substantial range of distance between these two extremes, however, the various embodiments will adjust the transmission power such that the signal strength as measured at the base station 11 remains essentially constant.

One skilled in the art will understand that obtaining a perfect constancy of signal quality as measured at the base station 11 is nearly impossible. Instead, the adjustments to the transmission power will help bring the signal strength as measured to within an essentially constant level during the normal course of use. Also, when using certain technologies such as WiDEN technology for the wireless communication device 10, the transmission power at certain bandwidths will fluctuate as an inherent nature of the modulation of the signal as much as 5 to 10 percent of the average transmission power. Thus, this known fluctuation will also affect the natural variation of the strength of signal as measured at the base station 11.

Certain embodiments account for the situation where the strength of signal as measured by the base station 11 will naturally increase because of the shortening of the distance between the wireless communication device 10 and the base station 11. In this situation, it is advantageous to not increase the transmission power of the wireless communication device 10 when the bandwidth increases because the signal quality at the base station 11 will not significantly improve. Instead, increasing the transmission power will only consume additional battery resources while not improving signal strength. Therefore, when the signal quality factor monitor 15 senses such an increase in the signal quality such that increasing the transmission power to account for an increase in bandwidth does not improve signal quality, the transmission power will not be increased.

Alternatively, embodiments account for the situation where the strength of signal naturally declines during use of the wireless communication device 10 near the outer boundaries of the communication ranges with the base station 11. Such an embodiment is described with reference to FIG. 3. In addition to monitoring the bandwidth 21 and monitoring a signal quality factor 22, the maximum transmission power monitor 16 monitors 30 the maximum transmission power for the wireless communication device, and the peak to average transmission power monitor 17 monitors 31 the peak to average transmission power for the wireless communication device 10. Then the transmission power setting unit 13 adjusts 32 the transmission power as a function, at least in part, of the bandwidth, the signal quality factor, the maximum transmission power, and the peak to average transmission power.

More specifically, the transmission power will not be adjusted above a predetermined amount. The predetermined amount is a ceiling that the transmission power should not exceed because the transmission power may reach above the wireless communication device's 10 transmission power limits. In particular, certain technologies for wireless communication systems, such as WiDEN technology, employ a signal modulation arrangement where the transmission power naturally fluctuates about an average transmission power. To avoid this natural fluctuation's pushing the transmission power past the wireless communication device's 10 limits, the transmission power setting unit 13 will not adjust the transmission power above an amount determined by the difference between the maximum transmission power and the peak to average transmission power for the wireless communication device 10.

Alternatively, the transmission power will not be increased above an amount determined by the difference between the maximum transmission power and the peak to average transmission power when the bandwidth is above a predetermined amount. Such an embodiment addresses the situation where in certain technologies, such as WiDEN technology, the power transmission fluctuations about the average transmission power are non-existent or when transmitting at a base level bandwidth, such as the 25 kHz level in WiDEN technology, minimal. Thus, the artificial ceiling created by the power fluctuations of WiDEN technology is no longer necessary when transmitting at the base level bandwidth. Therefore, the transmission power will not be increased above the difference between the maximum transmission power and the peak to average transmission power only if the bandwidth is above this base level or predetermined amount. If the wireless communication device is transmitting at the lower bandwidth, the transmission power can be increased up to the maximum transmission power for the wireless communication device 10.

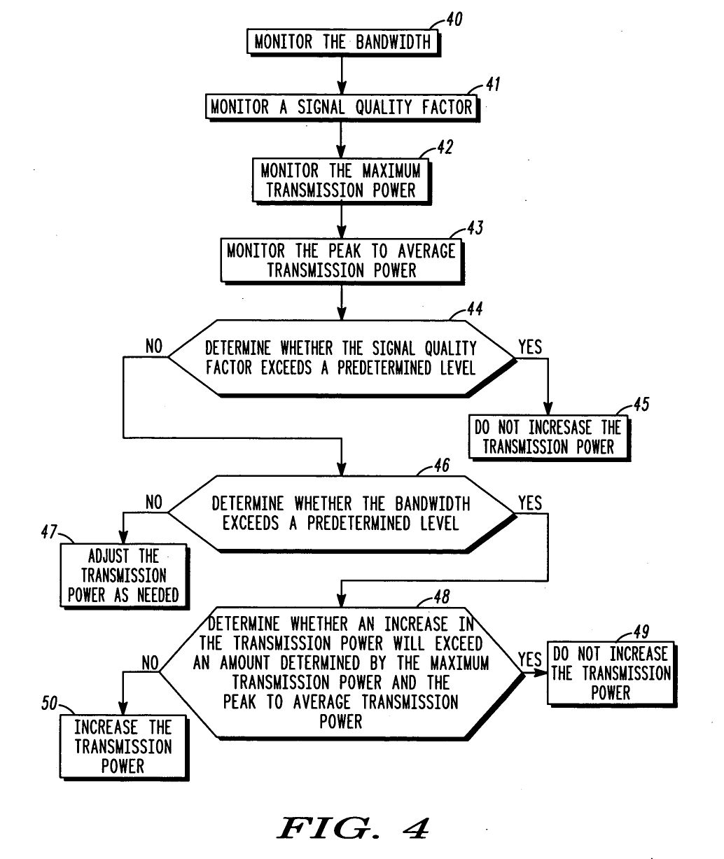

In a preferred embodiment as illustrated in FIG. 4, the bandwidth at which the wireless communication device 10 is transmitting is monitored 40. In addition, the signal quality factor is monitored 41, the maximum transmission power is monitored 42, and the peak to average transmission power is monitored 43. In response to these monitored values, it is determined 44 whether the signal quality factor exceeds a predetermined level. This predetermined level is determined as the level at which increasing the transmission power to account for increases in bandwidth will not improve the signal quality. If the signal quality factor is such that any loss in transmission power due to a change in the transmission bandwidth will not drop the signal quality below a minimum level, the transceiver 12 through the transmission power setting unit 13 will not increase the transmission power 45.

If the signal quality factor is not above the predetermined level, it is determined 46 whether the bandwidth exceeds a predetermined level. If the bandwidth does not exceed the predetermined level such as 25 kHz for a wireless communication device 10 using WiDEN technology, the transmission power will be adjusted 47 as necessary in response to the signal quality factor to maintain an essentially constant signal strength at the base station 11. If the bandwidth does exceed the predetermined level, it is determined 48 whether an increase in the transmission power will exceed an amount determined by the difference between the maximum transmission power and the peak to average transmission power. If the increase in transmission power will exceed this amount such that the fluctuations in transmission power will cause the transmission power to potentially exceed the maximum transmission power, the transmission power will not be increased 49. If an increase in transmission power will not exceed this determined amount, the transmission power is increased 50 as necessary to maintain an essentially constant signal quality at the base station 11. It should be noted that these various factors need not be monitored in any particular order. Alternatively, the order of the performance of the determination steps may be changed. Further, one should note that the various embodiments of the described method may be performed continuously during the use of the wireless communication device 10 to account for constant changes in the various monitored factors during use.

So configured, a wireless communication device can make more effective use of its own native bandwidth agility under at least some operating conditions by use of some or all of these adaptive power management techniques. By typically increasing the transmission power when the wireless communication device transmits at larger bandwidths, the wireless communication device provides a more consistent signal strength and quality of signal. Also, not increasing the transmission power when the signal strength is sufficiently high can lengthen battery life. Also, by monitoring the peak to average power, the transmission power can be set so as to not exceed the maximum transmission power of the wireless communication device.

Those skilled in the art will recognize that a wide variety of other modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
monitoring a bandwidth of a transmission channel for a wireless communication device;
monitoring a signal quality factor between the wireless communication device and a base station; and
adjusting a transmission power for the wireless communication device as a function, at least in part, of the bandwidth of the transmission channel for the wireless communication device and of the signal quality factor between the wireless communication device and the base station.

2. The method of claim 1 wherein monitoring a bandwidth of a transmission channel for a wireless communication device further comprises monitoring a bandwidth of a data transmission channel for a wireless communication device.

3. The method of claim 1 wherein monitoring a bandwidth of a transmission channel for a wireless communication device further comprises monitoring a bandwidth of a transmission channel for a wireless communication device that uses WiDEN communication technology.

4. The method of claim 3 wherein monitoring a bandwidth of a transmission channel for a wireless communication device using WiDEN communication technology further comprises detecting a transmission channel bandwidth of any one of:
25 kHz;
50 kHz;
75 kHz; and
100 kHz.

5. The method of claim 1 wherein monitoring a signal quality factor between the wireless communication device and a base station further comprises monitoring any one of:
a power control constant;
a magnitude of signal;
a ratio of desired signal to undesired signal; and
a bit error rate.

6. The method of claim 1 wherein the signal quality factor is determined by the base station and transmitted from the base station to the wireless communication device.

7. The method of claim 1 wherein adjusting a transmission power for the wireless communication device as a function, at least in part, of the bandwidth of the transmission channel for the wireless communication device and of the signal quality factor between the wireless communication device and the base station further comprises increasing the transmission power for the wireless communication device in response to monitoring an increase in the bandwidth of the transmission channel for the wireless communication device.

8. The method of claim 7 wherein increasing the transmission power for the wireless communication device in response to monitoring an increase in the bandwidth of the transmission channel for the wireless communication device further comprises increasing the transmission power such that a strength of signal as corresponds to a transmission from the wireless communication device as measured at the base station is essentially constant per unit bandwidth over a substantial range of distance between the wireless communication device and the base station.

9. The method of claim 1 wherein adjusting a transmission power for the wireless communication device as a function, at least in part, of the bandwidth of the transmission channel for the wireless communication device and of the signal quality factor between the wireless communication device and the base station further comprises not increasing the transmission power for the wireless communication device when the signal quality factor exceeds a predetermined amount.

10. The method of claim 1 further comprising:
monitoring a maximum transmission power for the wireless communication device;
monitoring a peak to average transmission power for the wireless communication device;
adjusting the transmission power for the wireless communication device as a function, at least in part, of the peak to average power for the wireless communication device and the maximum transmission power for the wireless communication device.

11. The method of claim 10 wherein monitoring a peak to average power further comprises determining a power fluctuation common to a transmission method used by the wireless communication device.

12. The method of claim 11 wherein determining a power fluctuation common to a transmission method used by the wireless communication device further comprises determining a power fluctuation common to a WiDEN technology based transmission method used by the wireless communication device.

13. The method of claim 10 wherein adjusting the transmission power for the wireless communication device as a function, at least in part, of the peak to average power for the wireless communication device and the maximum transmission power for the wireless communication device further comprises not increasing the transmission power for the wireless communication device above a level determined by a difference between the maximum transmission power for the wireless communication device and the peak to average power for the wireless communication device.

14. The method of claim 13 wherein not increasing the transmission power for the wireless communication device above a level determined by a difference between the maximum transmission power for the wireless communication device and the peak to average power for the wireless communication device further comprises not increasing the transmission power for the wireless communication device above a level determined by the difference between the maximum transmission power for the wireless communication device and the peak to average power for the wireless communication device when the bandwidth is above a predetermined amount.

15. The method of claim 14 wherein the predetermined amount is 25 kHz when the wireless communication device utilizes WiDEN transmission technology.

16. An apparatus comprising:
a wireless communication device transmission channel bandwidth monitor;
a wireless communication device signal quality factor monitor;
a wireless communication device transceiver that is responsive to the wireless communication device transmission channel bandwidth monitor and the wireless communication device signal quality factor monitor.

17. The apparatus of claim 16 wherein the wireless communication device transceiver that is responsive to the wireless communication device transmission channel bandwidth monitor and the wireless communication device signal quality factor monitor further comprises a transmission power setting means for adjusting the transmission power of the wireless communication device as a function of, at least in part, a monitored bandwidth and a monitored signal strength.

18. The apparatus of claim 16 further comprising:
a wireless communication device maximum transmission power monitor;
a wireless communication device peak to average transmission power monitor; and
the wireless communication device transceiver that is responsive to the wireless communication device transmission channel bandwidth monitor and the wireless communication device signal quality factor monitor is further responsive to the wireless communication device maximum transmission power monitor and the wireless communication device peak to average transmission power monitor.

19. The apparatus of claim 18 wherein the wireless communication device transceiver that is responsive to the wireless communication device transmission channel bandwidth monitor and the wireless communication device signal quality factor monitor and is further responsive to the wireless communication device maximum transmission power monitor and the wireless communication device peak to average transmission power monitor further comprises a transmission power setting means for adjusting the transmission power of the wireless communication device as a function of, at least in part, a monitored maximum transmission power and a monitored peak to average transmission power.

20. An apparatus comprising:
means for monitoring a bandwidth of a transmission channel for a wireless communication device;
means for monitoring a signal quality factor between the wireless communication device and a base station; and
means for adjusting a transmission power for the wireless communication device as a function, at least in part, of the bandwidth of the transmission channel for the wireless communication device and of the signal quality factor between the wireless communication device and the base station.

21. The apparatus of claim 20 further comprising:
means for monitoring a maximum transmission power for the wireless communication device;
means for monitoring a peak to average transmission power for the wireless communication device;
means for adjusting the transmission power for the wireless communication device as a function, at least in part, of the peak to average power.
